(19) United States
(12) Patent Application Publication
(10) Pub. No.: US 2017/0138132 A1
(43) Pub. Date: May 18, 2017

(54) Casing Coupler Mounted EM Transducers

(71) Applicant: HALLIBURTON ENERGY SERVICES, INC., HOUSTON, TX (US)

(72) Inventors: Glenn A. Wilson, Houston, TX (US); Burkay Donderici, Houston, TX (US)

(73) Assignee: HALLIBURTON ENERGY SERVICES, INC., HOUSTON, TX (US)

(21) Appl. No.: 15/118,462

(22) PCT Filed: Apr. 2, 2014
(86) PCT No.: PCT/US2014/032692

§ 371 Date: Aug. 11, 2016

(51) Int. Cl. E21B 17/02; G01V 3/28; E21B 47/12; E21B 49/00; E21B 17/00; E21B 17/042

(52) U.S. Cl. CPC E21B 17/028; E21B 17/003; E21B 17/042; E21B 47/122; E21B 49/00; G01V 3/28; E21B 33/14

(57) ABSTRACT

An illustrative casing coupler for a permanent electromagnetic (EM) monitoring system, the casing coupler includes a tubular body having threaded ends for connecting casing tubulars together, and a wire coil that encircles the tubular body and transmits and/or receives EM signals.

### BACKGROUND

Oilfield operators are faced with the challenge of maximizing hydrocarbon recovery within a given budget and timeframe. While they perform as much logging and surveying as feasible before and during the drilling and completion of production and, in some cases, injection wells, the information gathering process does not end there. It is desirable for the operators to track the movement of fluids in and around the reservoirs during production as this information enables them to adjust the distribution and rates of production among the producing and/or injection wells to avoid premature water breakthroughs and other obstacles to efficient and profitable operation. Moreover, such information gather further enables the operators to better evaluate treatment and secondary recovery strategies for enhanced hydrocarbon recoveries.

The fluid saturating the formation pore space is often measured in terms of a hydrocarbon fraction and a water fraction. Due to the solubility and mobility of ions in water, the water fraction lends itself to indirect measurement via a determination of formation resistivity. The ability to remotely determine and monitor formation resistivity is of direct relevance to long term reservoir monitoring, particularly for enhanced oil recovery (EOR) operations with water flooding and/or CO₂ injection. Hence, a number of systems have been proposed for performing such remote formation resistivity monitoring.

One such proposed system employs “electrical resistivity tomography” (ERT), which implements galvanic electrodes that suffer from variable and generally degrading contact resistance with the formation due to electrochemical degradation of the electrode. This variability directly affects data quality and survey repeatability. See, e.g., J. Deceuster, O. Kaufmann, and V. Van Camp, 2013, “Automated identification of changes in electrode contact properties for long-term permanent ERT monitoring experiments” Geophysics, vol. 78 (2), E79-E94. There are difficulties associated with ERT on steel casing. See, e.g., P. Bergmann, C. Schmidt-Hattenberger, D. Kiessling, C. Rucker, T. Labitzke, J. Henninges, G. Baumann, and H. Schutt, 2012, “Surface-downhole electrical resistivity tomography applied to monitoring of CO2 storage at Ketzin, Germany” Geophysics, vol. 77 (6), B253-B267. See also R. Tondel, J. Ingham, D. LaBrecque, H. Schutt, D. McCormick, R. Godfrey, J. A. Rivero, S. Dingwall, and A. Williams, 2011, “Reservoir monitoring in oil sands: Developing a permanent cross-well system” Presented at SEG Annual Meeting, San Antonio. Thus, it has been preferred for ERT systems to be deployed on insulated (e.g., fiberglass) casing. However, insulated casing is generally impractical for routine oilfield applications.

Crosswell electromagnetic (EM) tomography systems have been proposed as a non-permanent solution to reservoir monitoring. See, e.g., M. J. Wilt, D. L. Alumbaugh, H. F. Morrison, A. Becker, K. H. Lee, and M. Deszcz-Pan, 1995, “Crosswell electromagnetic tomography: System design considerations and field results” Geophysics, 60 (3), 871-885.The proposed crosswell EM tomography systems involve the wireline deployment of inductive transmitters and receivers in separate wells. However, the wells in a typical oilfield are cased with carbon steel casing, which is both highly conductive and magnetically permeable. Hence, the magnetic fields external of the casing are greatly reduced. Moreover, the casing is typically inhomogeneous, having variations in casing diameter, thickness, permeability, and conductivity, resulting from manufacturing imperfections or from variations in temperature, stress, or corrosion after emplacement. Without precise knowledge of the casing properties, it is difficult to distinguish the casing-induced magnetic field effects from formation variations. See discussion in E. Nichols, 2003, “Permanently emplaced electromagnetic system and method of measuring formation resistivity adjacent to and between wells” U.S. Pat. No. 6,534,986.

There do exist a number of apparently-speculative publications relating to permanent EM reservoir monitoring systems. See, e.g., Nichols 2003; K. M. Strack, 2003, “Integrated borehole system for reservoir detection and monitoring” US Pat. App. 2003/0038634; and A. Reiderman, L. G. Schoonover, S. M. Dutta, and M. B. Rabinovich, 2010, “Borehole transient EM system for reservoir monitoring” US Pat. App. US2010/0271030.However, it does not appear that any such systems have yet been developed for deployment, and may in fact be unsuitable for their proposed uses. For example, Nichols 2003 proposes the incorporation of long slots in the steel casing to disrupt the flow of induced counter currents in the casing, but slotted casing may be expected to have significantly weaker structural integrity and does not appear to be a viable solution. It appears that the other proposed systems fail to adequately account for the presence of casing effects, and in fact the present authors believe such effects would render the performance of these other proposed systems inadequate.

### BRIEF DESCRIPTION OF THE DRAWINGS

Accordingly, there are disclosed in the drawings and the following description various permanent electromagnetic (EM) monitoring devices, systems, and methods, employing casing coupler mounted EM transducers with high permeability layers. In the drawings:

FIG. 1 is a schematic depiction of an illustrative permanent EM monitoring system.

FIGS. 2A-2D show illustrative casing couplers having EM transducers for permanent EM monitoring.

FIG. 3 is a flow chart of an illustrative permanent EM monitoring method.

It should be understood, however, that the specific embodiments given in the drawings and detailed description do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Certain disclosed device, system, and method embodiments provide permanent electromagnetic (EM) monitoring of the regions around and between wells. Casing tubulars are coupled together with a casing coupler having an EM transducer module. The EM transducer module may detect a magnetic field with a wire coil that encircles the casing coupler, with a layer of soft magnetic material arranged between the wire coil and the casing coupler. Alternatively, the EM transducer module may include a piezoelectric or magnetostrictive element that detects the magnetic field and thereby applies stress to an optical fiber, the EM transducer further including a layer of soft magnetic material that substantially encircles the casing coupler to amplify a signal response of the magnetic field sensing element. A well interface system communicates with the EM transducer module to transmit and/or collect EM signal measurements over time.

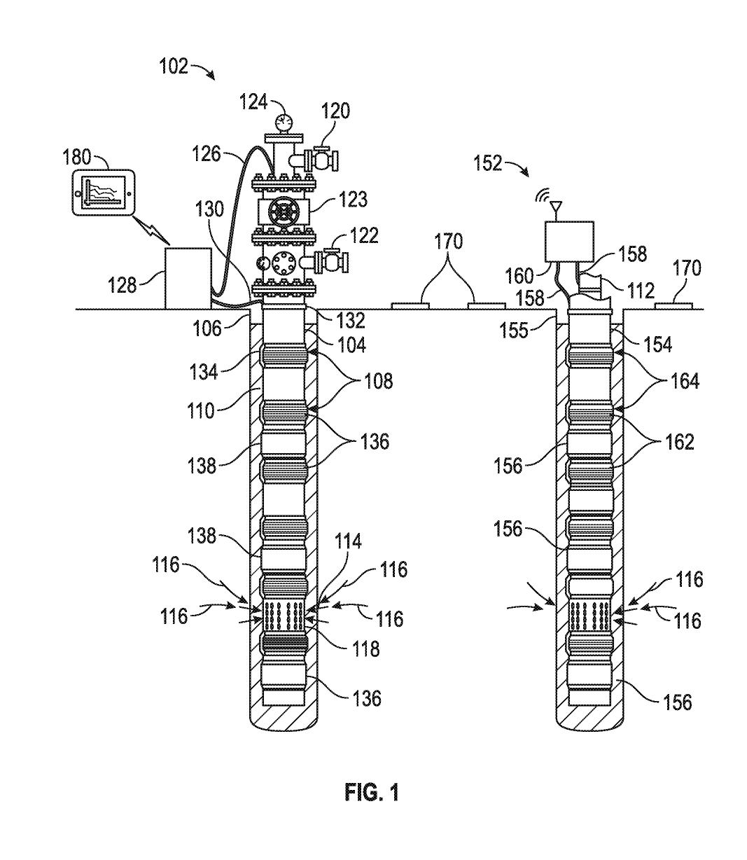

FIG. 1 shows a well 102 equipped with an illustrative embodiment of a permanent electromagnetic (EM) monitoring system. The illustrated well 102 has been constructed and completed in a typical manner, and it includes a casing string 104 positioned in a borehole 106 that has been formed in the earth by a drill bit. The casing string 104 includes multiple casing tubulars 138 (usually 30 foot long carbon steel tubulars) connected end-to-end by couplings or casing couplers 108. Cement 110 has been injected between an outer surface of the casing string 104 and an inner surface of the borehole 106 and allowed to set. The cement enhances the structural integrity of the well and seals the annulus around the casing against undesired fluid flows. Though well 102 is shown as entirely cemented, in practice certain intervals may be left without cement, e.g., in horizontal runs of the borehole where it may be desired to facilitate fluid flows.

Perforations 114 have been formed at one or more positions along the borehole 106 to facilitate the flow of a fluid 116 from a surrounding formation into the borehole 106 and casing string 104 and thence to the surface. The casing string 104 may include pre-formed openings 118 in the vicinity of the perforations 114, or it may be perforated at the same time as the formation. Typically the well 102 is equipped with a production tubing string positioned in an inner bore of the casing string 104. (A counterpart production tubing string 112 is visible in the cut-away view of well 152.) One or more openings in the production tubing string accept the borehole fluids and convey them to the earth's surface and onward to storage and/or processing facilities via production outlet 120. The well head may include other ports such as port 122 for accessing the annular space(s) and a blowout preventer 123 for blocking flows under emergency conditions. Various other ports and feed-throughs are generally included to enable the use of external sensors 124 and internal sensors. Illustrative cable 126 couples such sensors to a well interface system 128. Note that this well configuration is merely for illustrative purposes, is not to scale, and is not limiting on the scope of the disclosure.

The interface system 128 may supply power to the transducers and provides data acquisition and storage, possibly with some amount of data processing. Alternatively, the transducers may be battery powered or downhole power generation may be utilized. As depicted, the permanent EM monitoring system is coupled to the interface system 128 via an armored cable 130, which is attached to the exterior of casing string 104 by straps 132 and protectors 134. (Protectors 134 guide the cable 130 over the casing coupler 108 and shield the cable 130 from being pinched between the coupling and the borehole wall.) The cable 130 connects to an EM transducer module 136 of each casing coupler 108. Alternatively, the transducer modules 136 may communicate wirelessly with the interface system 128.

FIG. 1 further shows a second well 152 having a second casing string 154 in a borehole 155, with EM transducer modules 162 as part of casing couplers 164 and communicating via one or more cables 158 to a second well interface system 160. The casing couplers 164 and EM transducer modules 162 of the second well 152 may be similar to the casing couplers 108 and EM transducer modules 136 of the first well 102.

The second well interface system 160 may be connected in a wired or wireless fashion to the first well interface system 128 or to a central system that coordinates the operation of the wells. Additional wells and well interfaces may be included in the coordinated operation of the field and the permanent EM monitoring system. (Some system embodiments employ EM transducer modules in only one well, but it is generally preferred to provide additional EM transducer modules on the surface and/or in other nearby wells.)

The illustrated system further includes surface transducer modules 170. The surface transducer modules 170 may employ spaced-apart electrodes that create or detect EM signals, wire coils that create or detect EM signals, or magnetometers or other EM sensors to detect EM signals. At least one of the transducer modules 136, 162, 170 transmits EM signals while the rest obtain responsive measurements. In some implementations, each of the transducer modules is a single-purpose module, i.e., suitable only for transmitting or receiving, but it is contemplated that in at least some implementations, the system includes one or more transducer modules that can perform both transmitting and receiving.

The EM transducer modules transmit or receive arbitrary waveforms, including transient (e.g., pulse) waveforms, periodic waveforms, and harmonic waveforms. The transducer modules can further measure natural EM fields including magnetotelluric and spontaneous potential fields. Suitable EM signal frequencies for reservoir monitoring typically include the range from 1 Hz to 10 kHz. In this frequency range, the modules may be expected to detect signals at transducer spacings of up to about 200 feet, though of course this varies with transmitted signal strength and formation conductivity.

FIG. 1 further shows a tablet computer 180 that communicates wirelessly with the well interface system 128 to obtain and process EM measurement data and to provide a representative display of the information to a user. The computer 180 can take different forms including a laptop, desktop computer, and virtual cloud computer. Whichever computer embodiment is employed includes software that configures the computer's processor(s) to carry out the necessary processing and to enable the user to view and preferably interact with a display of the resulting information. The processing includes at least compiling a time series of measurements to enable monitoring of the time evolution, but may further include the use of a geometrical model of the reservoir that takes into account the relative positions and configurations of the transducer modules and inverts the measurements to obtain one or more parameters. Those parameters may include a resistivity distribution, a conductivity, and an estimated fluid (e.g., water) saturation.

The computer 180 may further enable the user to adjust the configuration of the transducers, employing such parameters as firing rate of the transmitters, firing sequence of the transmitters, transmit amplitudes, transmit waveforms, transmit frequencies, receive filters, and demodulation techniques. In some contemplated system embodiments, the computer further enables the user to adjust injection and/or production rates to optimize production from the reservoir.

At least one of the references discussed in the background contemplates the winding of wire coils around the casing to serve as a magnetic dipole antenna. However carbon steel, the typical casing material, has a high conductivity (greater than 10⁶ S/m). This conductivity enables the casing to support the flow of induced countercurrents which interfere with the transmitted or received signal. Moreover, steel itself is typically a “hard” magnetic material, meaning that it has a lossy hysteresis curve that further dissipates EM energy. These characteristics make the casing itself a poor choice as the core of a magnetic transducer, offsetting any gains realized by the casing's relative permeability. (The relative magnetic permeability of carbon steel is approximately 100.) The effective magnetic permeability of a carbon steel casing core can be less than one, yielding a degradation of the desired signals.

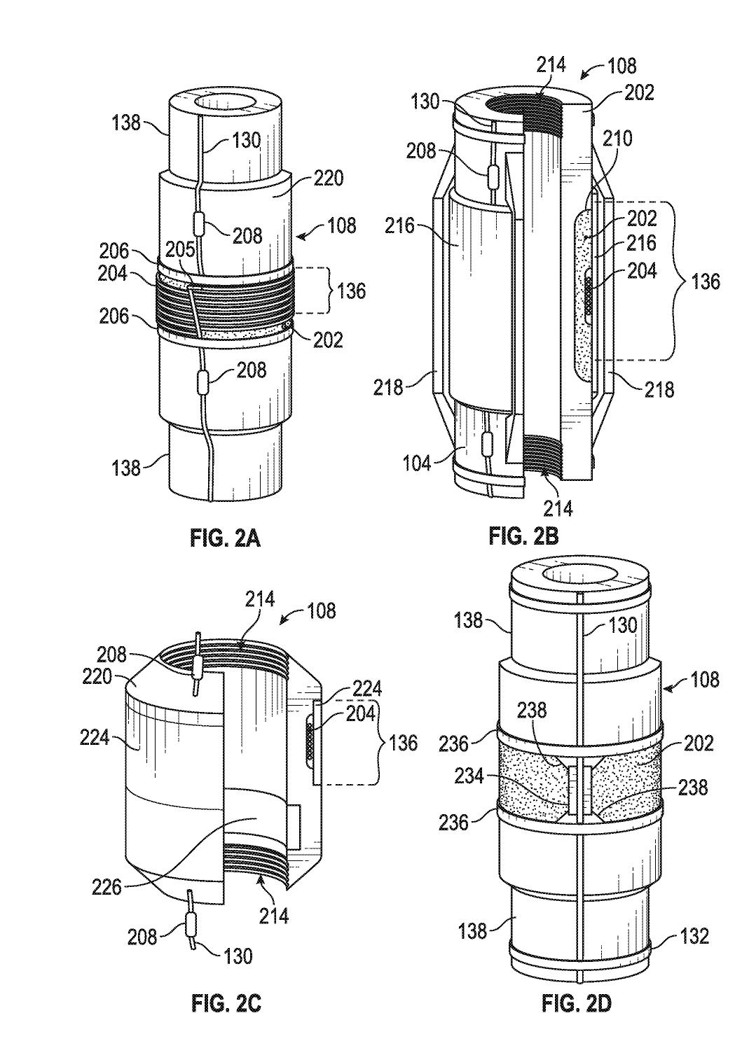

Accordingly, the illustrative EM transducer module configurations shown in FIGS. 2A-2D employ a layer of material that is non-conductive (a bulk conductivity of no more than 1 S/m and preferably less than 10⁻² S/m) and having a high relative magnetic permeability (at least 200 and preferably greater than 500). The layer of material acts as a preferred channel for the magnetic field lines, reducing the magnetic field in the casing coupler 108 and thereby lessening the signal degradation caused therefrom.

FIG. 2A depicts an illustrative casing coupler 108 having an EM transducer 136 for permanent EM monitoring. As depicted, the casing coupler 108 has female threadforms (shown in FIG. 2B as female threads 214) enabling casing tubulars 138 to be threaded into the top and bottom of the casing coupler 108. The EM transducer 136 is integrated with the casing coupler 108, having a wire coil 204 (hereinafter “coil 204”) that encircles the casing coupler 108 and a layer of soft magnetic material 202 (hereinafter “material 202”) between the coil 204 and the casing coupler 108. Straps 206 hold the coil 204 in place on top of the casing coupler 108. A controllable switch 205 is provided to switch the coil 204 into and out of the electrical path, thereby controlling whether the coil 204 is energized by a current along cable 130 (or whether an incident EM field can induce a current along cable 130). Connectors 208 are provided to facilitate the connection of cable 130 to the illustrative EM transducer 136, enabling assembly and calibration of the EM transducer 136 with the casing coupler 108 prior to delivery on-site, thus minimizing disruption of the casing string assembly and running process.

The thicker the layer of material 202 and the higher the relative permeability of the material 202, the more effective the material 202 will be at reducing the effects of the casing tubular 138 and casing coupler 108. The material 202 is preferably a soft magnetic material such as a ferrite. The material 202 may be suspended in a nonconductive matrix material suitable for downhole use. Such matrix materials include vulcanized rubber, polymers (e.g., polytetrafluoroethylene or poly-ether-ether-ketone), epoxy, and ceramics. The casing coupler 108 and material 202 thickness is limited by the mechanics of the well. Well completion engineers generally limit the radial dimension of the annulus around the casing to no more than about one inch. As space must be permitted for the flow of cement slurry, the thickness of the casing coupler 108 and material 202 (and any windings or protection thereon) may need to be limited to about one-half inch. Material 202 thicknesses of as little as 1 mm are expected to enhance performance, though thicknesses of at least 5 mm are preferred. One of skill in the art will appreciate that thicknesses of less than 1 mm or greater than 5 mm (e.g., 10 mm, 15 mm, etc.) may be used. Moreover, the thickness need not be uniform, though performance may be dominated by the thickness of the thinnest regions proximate to the coil.

The axial dimension of the material 202 is also a factor in improving the EM transducer module's 136 performance. Generally speaking, the larger the ratio of the material's 202 axial dimension to the coil's 204 axial dimension, the greater the suppression of induced counter currents. However, diminishing returns are observed at higher ratios, so in practice the ratio of axial dimensions may be kept in a range between 2 and 10. Ratios of at least 3 are preferred, with minimum values of 4 and 6 being particularly contemplated.

FIG. 2B shows a partially-sectioned view of a more protective configuration in which a recess 210 has been machined into the wall of the casing coupler 108 and filled with the material 202. The material 202 may have an axial dimension at least twice an axial dimension of the coil 204. The coil 204 overlays the material 202 and is protected beneath a thin shell 216 of nonconductive, nonmagnetic material such as fiberglass or one of the matrix materials mentioned above. As depicted, the casing coupler 108 includes female threads 214 at both ends for coupling casing tubulars (e.g., casing tubulars 138) together, and a plurality of non-magnetic centralizing arms 218 to further protect the casing coupler 108. Electronics may be included with the casing coupler 108 to derive power from the cable 130 and control the transmission or reception process. The electronics may further process and store measurement data and transmit the measurement data to the interface system via the cable 130 or some other telemetry mechanism.

The embodiment of FIG. 2B necessitates significant modification of the casing coupler 108. FIG. 2C is a partially-sectioned view of an alternative casing coupler 108 with an EM transducer module 136. The module's body 220 is primarily formed from the ferritic material, with a circumferential groove cut for the coil 204 and a protective shell 224. The body 220 further includes a recess 226 for electronics. Connectors 208 may be provided to facilitate connection of the cable 130. In an alternative implementation, body 220 may be at least partially realized as a bladder that can be inflated with a ferromagnetic fluid or a suspension of magnetic nanoparticles. Such inflation can be performed before, during, or after deployment in the borehole.

The transducer module embodiments of FIGS. 2A-2C each include a coil 204 as the primary transducer element. FIG. 2D employs an optical sensing approach. The cable 130 includes an optical fiber that interacts with a magnetic field sensing element 234 (hereinafter “sensing element 234”). A layer 202 of nonconductive, high-permeability material encircles the casing coupler 108 except for where the magnetic field sensing element 234 is arranged, thus amplifying the magnetic field across the sensing element 234, intensifying the magnetic field's effect on the optical fiber. Nonmagnetic inserts 238 may be provided to modify the shape of the field and thereby improve the transducer's performance. Sensing element 234 may be a piezoelectric or magnetostrictive material that modulates the strain in the optical fiber in relation to the sensed field. Straps 236 secure the sensing element 234 and cable 130 to the casing coupler 108. Alternatively, the sensing element 234 may be a piezoelectric transducer or an atomic magnetometer.

For each of the disclosed embodiments, the method and materials of fabrication are chosen for the specific application. In some cases, the modules may be designed specifically for high pressure (e.g., 35,000 psi) and high temperature (e.g., >260° C.) environments, with continuous vibrations expected for extended periods of time, such as are typically encountered in oilfield wells. The modules may be designed to enable mass production while facilitating field deployment as system as part of a permanent EM monitoring system.

We note here that each of the transducer modules are shown as a wired embodiment, i.e., with the cable 130 physically connecting to the transducer modules. Such modules should be made compliant with industry standards such as the Intelligent Well Interface Standard (IWIS). (Compliance with such low power standards is further facilitated by the improved performance and reduced dissipation enabled by the use of the high permeability layers.) However, it is not a requirement for the transducer modules to be wired to the interface system. Rather, one or more of the modules may be self-contained. Wireless communication may be supported via acoustic or EM transmission. Power may be obtained from batteries or super-capacitors and, for long term monitoring, the power may be replenished by fuel cells, energy harvesting, and/or wireless power transmission from a wireline tool. In both the wired and self-contained embodiments, the EM transducer modules benefit from being non-contact sensors and hence unaffected contact resistance variations.

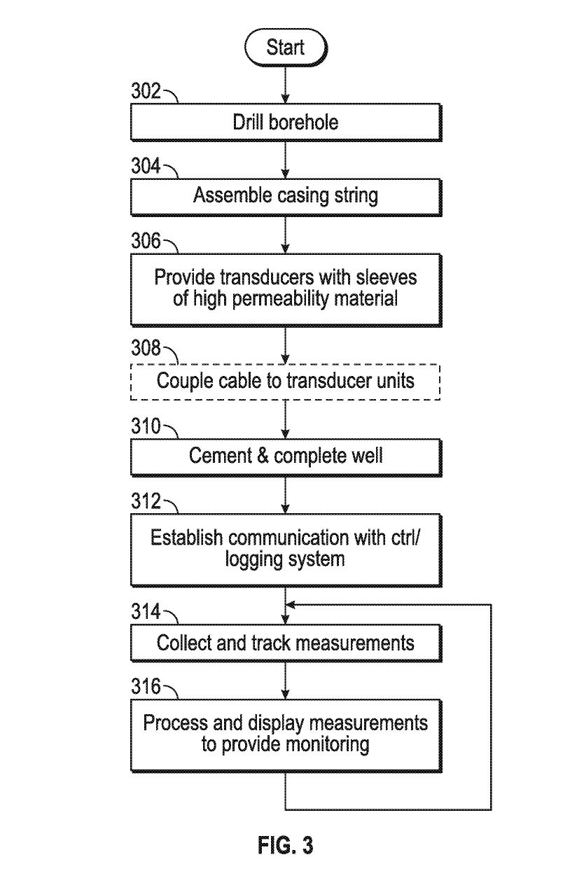

FIG. 3 is a flow diagram of an illustrative permanent EM monitoring method. The method begins in block 302 with a crew drilling a borehole. In block 304, the crew assembles a casing string and lowers it into place in the borehole. During this assembly and running process, the crew couples together casing string tubulars with casing collars having an EM transducer module with a layer of nonconductive, high permeability material in block 306. In block 308, the crew optionally connects the transducer module to an armored cable and straps the cable to the casing as it is run into the borehole. The cable may provide power and/or wiring or optical fibers for interrogation and/or telemetry. In block 310, the crew cements the well, creating a permanent installation of the casing string, including the casing couplers having EM transducer modules. The crew may further complete the well, performing any needed perforation, treatment, equipping, and conditioning operations to optimize production. The well may alternatively be an injection well or a “dry well” created solely for monitoring.

In block 312, communication is established between the well interface system and the EM transducer modules (e.g., wirelessly, or by connecting the cable conductors to the appropriate terminals). In block 314, the interface system periodically induces the transducer modules to operate in a time, frequency, or code-multiplexed manner and collects measurements. The measurements may be indicative of signal amplitude, attenuation, phase, delay, spectrum, or other suitable variables from which the desired formation information can be derived. Measurement of natural or environmental EM signals may also be performed at this stage. In block 316, the interface system or an attached computer processes the measurements and provides a representative display to a user to enable long term monitoring of the reservoir status. Blocks 314 and 316 are repeated to build up a time history of the measurements.

Embodiments disclosed herein include:

A: A casing coupler for a permanent electromagnetic (EM) monitoring system, the casing coupler including a tubular body having threaded ends for connecting casing tubulars together, and a wire coil that encircles the tubular body and transmits and/or receives EM signals.

B: A permanent electromagnetic (EM) monitoring method that includes lowering a casing string into a borehole, coupling casing tubulars together with a casing coupler having an EM transducer module, cementing the casing string in place, and transmitting and/or receiving EM signals with a wire coil of the EM transducer.

C: A casing coupler for a permanent electromagnetic (EM) monitoring system, the coupler including a tubular body having threaded ends for connecting casing tubulars together, and a magnetic field sensing element coupled to the tubular body

D: A permanent electromagnetic (EM) monitoring method that comprises lowering a casing string into a borehole, coupling casing tubulars together with a casing coupler having an EM transducer module, cementing the casing in place, collecting EM signals with a magnetic field sensing element of the EM transducer, and communicating the EM signals to a well interface system.

Each of embodiments A, B, C, and D may have one or more of the following additional elements in any combination:

Element 1: a layer of soft magnetic material between the wire coil and the casing coupler. Element 2: each of the threaded ends having a female threadform. Element 3: the wire coil and magnetic material are at least partially arranged within a recess of the tubular body. Element 4: an internal battery which powers the wire coil. Element 5: a cable to communicate with a well interface system. Element 6: the cable including an optical fiber to communicate with the well interface system. Element 7: wireless communication equipment to communicate with a well interface system. Element 8: the layer of soft magnetic material has an axial dimension at least twice an axial dimension of the wire coil. Element 9: the layer of soft magnetic material has a thickness between 1 mm and 15 mm. Element 10: the layer of soft magnetic material has a relative permeability of at least 200 and a conductivity of less than 1 S/m.

Element 11: including reducing the magnetic field in the casing coupler with a layer of soft magnetic material arranged between the wire coil and a tubular body of the casing coupler. Element 12: where said EM signals are communicated between the EM transducer and a well interface system via a cable. Element 13: where communicating the EM signals is performed wirelessly. Element 14: including inverting received EM signals to monitor at least one parameter of a subsurface formation over time. Element 15: the parameter is a conductivity. Element 16: the parameter is a fluid saturation.

Element 17: a layer of soft magnetic material that substantially encircles the casing coupler to amplify a signal response of the magnetic field sensing element. Element 18: the magnetic field sensing element is a piezoelectric or magnetostrictive material. Element 19: including an optical fiber that couples the magnetic field sensing element to a well interface system.

Element 20: collecting EM signals includes modulating a strain in an optical fiber with the magnetic field sensing element, and where the magnetic field sensing element is a piezoelectric or magnetostrictive material.

Numerous variations and modifications will become apparent to those skilled in the art once the above disclosure is fully appreciated. For example, the figures show system configurations suitable for reservoir monitoring, but they are also readily usable for treatment operations, cementing operations, active and passive electromagnetic surveys, and production monitoring. As another example, the illustrated transducers have coaxial coil configurations, but tilted coils could alternatively be employed to provide azimuthal and/or multi-component sensitivity. It is intended that the following claims be interpreted to embrace all such variations and modifications.

What is claimed is:

1. A casing coupler for a permanent electromagnetic (EM) monitoring system, the casing coupler comprising:
a tubular body deployed in a borehole as part of a permanent casing string, the tubular body having threaded ends for connecting casing tubulars together; and
a wire coil that encircles the tubular body and that periodically transmits and/or receives EM signals to determine a subsurface formation parameter at different times.

2. The casing coupler of claim 1, further comprising a layer of soft magnetic material between the wire coil and the casing coupler.

3. The casing coupler of claim 1, wherein each of said threaded ends have a female threadform.

4. The casing coupler of claim 1, wherein the wire coil and magnetic material are at least partially arranged within a recess of the tubular body.

5. The casing coupler of claim 1, further comprising an internal battery which powers the wire coil.

6. The casing coupler of claim 1, further comprising a cable to communicate with a well interface system.

7. The casing coupler of claim 6, wherein the cable includes an optical fiber to communicate with the well interface system.

8. The casing coupler of claim 1, further comprising wireless communication equipment to communicate with a well interface system.

9. The casing coupler of claim 2, wherein the layer of soft magnetic material has an axial dimension at least twice an axial dimension of the wire coil.

10. The casing coupler of claim 2, wherein said layer of soft magnetic material has a thickness between 1 mm and 15 mm.

11. The casing coupler of claim 2, wherein said layer of soft magnetic material has a relative permeability of at least 200 and a conductivity of less than 1 S/m.

12. A permanent electromagnetic (EM) monitoring method that comprises:
lowering a casing string into a borehole;
coupling casing tubulars together with a casing coupler having an EM transducer module;
cementing the casing string in place; and
periodically transmitting and/or receiving EM signals with a wire coil of the EM transducer to determine a subsurface formation parameter at different times.

13. The method of claim 12, further comprising reducing the magnetic field in the casing coupler with a layer of soft magnetic material arranged between the wire coil and a tubular body of the casing coupler.

14. The method of claim 12, wherein said EM signals are communicated between the EM transducer and a well interface system via a cable.

15. The method of claim 12, wherein communicating said EM signals is performed wirelessly.

16. The method of claim 12, further comprising inverting received EM signals to monitor at least one parameter of a subsurface formation over time.

17. The method of claim 16, wherein the parameter is a conductivity.

18. The method of claim 16, wherein the parameter is a fluid saturation.

19. A casing coupler for a permanent electromagnetic (EM) monitoring system, the coupler comprising:
a tubular body deployed in a borehole as part of a permanent casing string, the tubular body having threaded ends for connecting casing tubulars together; and
a magnetic field sensing element coupled to the tubular body to periodically receive EM signals to determine a subsurface formation parameter at different times.

20. The casing coupler of claim 19, further comprising a layer of soft magnetic material that substantially encircles the casing coupler to amplify a signal response of the magnetic field sensing element.

21. The casing coupler of claim 20, wherein the magnetic field sensing element is a piezoelectric or magnetostrictive material.

22. The casing coupler of claim 20, further comprising an optical fiber that couples the magnetic field sensing element to a well interface system.

23. A permanent electromagnetic (EM) monitoring method that comprises:
lowering a casing string into a borehole;
coupling casing tubulars together with a casing coupler having an EM transducer module;
cementing the casing in place;
periodically collecting EM signals with a magnetic field sensing element of the EM transducer; and
communicating said EM signals to a well interface system, wherein the EM signals are used to determine a subsurface formation parameter at different times.

24. The method of claim 23, wherein the collecting EM signals includes modulating a strain in an optical fiber with the magnetic field sensing element, and wherein the magnetic field sensing element is a piezoelectric or magnetostrictive material.
